(19) United States
(12) Patent Application Publication
(10) Pub. No.: US 2017/0133162 A1
(43) Pub. Date: May 11, 2017

(54) DEVICE FOR STORING ELECTRICAL ENERGY

(71) Applicant: INTERNATIONAL BUSINESS MACHINES COPORATION, Armonk, NY (US)

(72) Inventors: Barbara A. Jones, San Jose, CA (US); Robert D. Miller, San Jose, CA (US); Aakash Pushp, San Jose, CA (US); Heike E. Riel, RUESCHLIKON (CH)

(21) Appl. No.: 14/933,425

(22) Filed: Nov. 5, 2015

(51) Int. Cl. H01G 9/20

(52) U.S. Cl. CPC H01G 9/2018

(57) ABSTRACT

A device for storing electrical energy comprises a photo electrode, having a semiconductor layer with a photo dye thereon, a counter electrode, a reservoir comprising a solvent, a first redox mediator for enabling a redox reaction at the photo electrode, a second redox mediator for enabling a redox reaction at the counter electrode, wherein the photo electrode and the counter electrode are at least partly in the solvent, the first redox mediator is adapted to form an entity that is soluble in the solvent when the first redox mediator is in its reduced state, and an entity that is insoluble in the solvent when the first redox mediator is in its oxidized state.

### BACKGROUND

The invention relates to a device for storing electrical energy. More particularly, the invention relates to a device for storing electrical energy that comprises a photo electrode with a photo dye thereon.

Solar energy is an energy source that is a widely available and sustainable. Novel methods and devices by which to efficiently capture and store this form of energy is a great challenge. A number of technologies based on photovoltaics, solar cells, fuel cells, water-splitting, and several others have been proposed and are currently being intensively investigated for efficient energy harvesting. In particular, advances have been made in the solar cell technology in the recent years by exploring low band-gap semiconductor junctions, dye-sensitized solar cells (DSSCs) or more recently perovskite-based solar cells.

For storage purposes, one usual approach is to first convert the solar energy into an electrical form and then further down-convert this electrical energy into an electrochemical form with the use of a stand-alone battery.

A DSSC cell, also denoted as Graetzel cell, comprises a photo electrode with a photo dye. Light is absorbed on the photo electrode by the dye, which upon photo-excitation then transfers its electron to the conduction band of a semiconductor. The electron travels from the photo electrode to a counter electrode via an external circuit, thereby generating a current flow. The photo electrode and the counter electrode are arranged in an electrolyte solution comprising a redox mediator. The photo-excited dye gets reduced by the electron provided by the redox mediator, which in turn gets oxidized. The oxidized redox mediator then collects an electron on the counter electrode and gets reduced. This cycle continues during illumination.

### SUMMARY

According to an embodiment of the invention, a device for storing electrical energy comprises a photo electrode, having a semiconductor layer with a photo dye thereon, a counter electrode, a reservoir comprising a solvent, a first redox mediator for enabling a redox reaction at the photo electrode, a second redox mediator for enabling a redox reaction at the counter electrode, wherein the photo electrode and the counter electrode are at least partly in the solvent, the first redox mediator is adapted to form an entity that is soluble in the solvent when the first redox mediator is in its reduced state, and an entity that is insoluble in the solvent when the first redox mediator is in its oxidized state.

### BRIEF DESCRIPTION OF THE SEVERAL VIEWS OF THE DRAWINGS

FIG. 1 illustrates a schematic view of a device for storing electrical energy according to an embodiment, the device being operated in a charging cycle;

FIG. 2 illustrates a schematic view of the device according to FIG. 1, the device being in a charged state;

FIG. 3 illustrates a schematic view of the device according to FIG. 1, the device being operated in a discharging cycle;

FIG. 4 illustrates a schematic view of another embodiment of a device for storing electrical energy, the device comprising a membrane and being operated in a charging cycle;

FIG. 5 illustrates a schematic view of the device according to FIG. 4, the device being operated in a discharging cycle;

FIG. 6 illustrates a schematic view of another embodiment of a device for storing electrical energy, the device comprising a coated counter electrode and being operated in a charging cycle;

FIG. 7 shows a cross section of an embodiment of the device of FIG. 1 in more detail;

FIG. 8 shows a cross section of the device of FIG. 6 in more detail;

FIG. 9 shows method steps of a charging cycle; and

FIG. 10 shows method steps of a discharging cycle.

### DETAILED DESCRIPTION

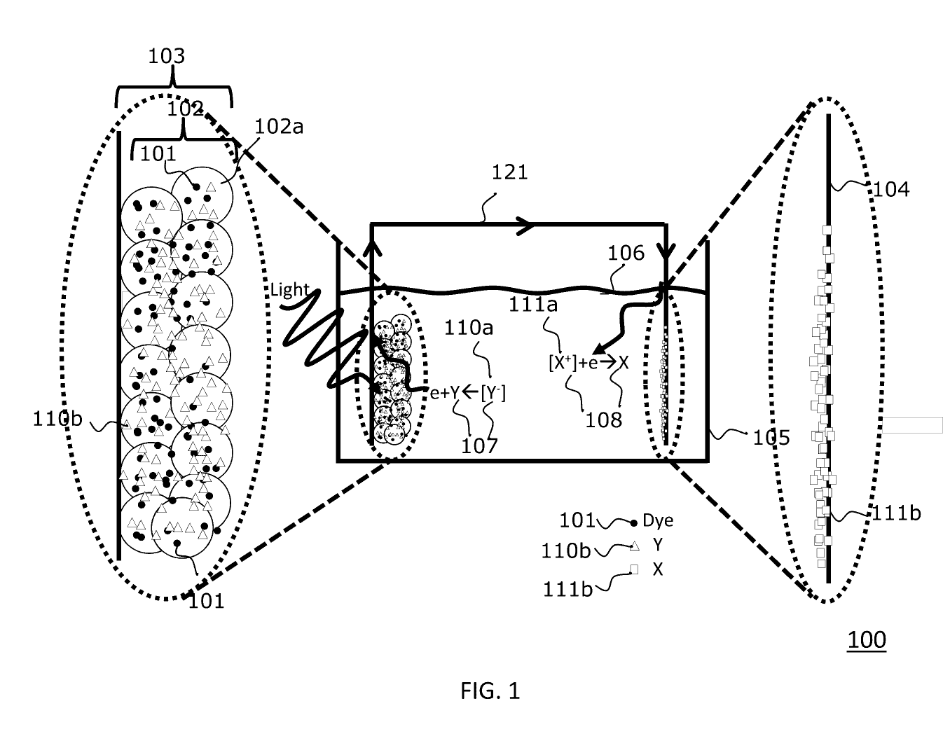

In reference to FIGS. 1-10, some general aspects and terms of embodiments are described.

A redox mediator, also often denoted as a redox couple or redox shuttle, may be defined as a reducing species and its corresponding oxidized form or in other words a redox mediator may be defined as the two species of a half-reaction involving oxidation or reduction.

A device 100 for storing electrical energy is provided. The device 100 comprises a photo electrode 103 having a semiconductor layer 102 with a photo dye 101 thereon. The photo dye 101 may be embodied as a molecular dye that absorbs sunlight, e.g. a molecular dye based on ruthenium or other dyes used in conventional DSSC cells.

The device 100 comprises further a counter electrode 104 opposite to the photo electrode 103 and a reservoir 105 filled with a solvent 106. According to a preferred embodiment the solvent is water. The photo electrode 103 and the counter electrode 104 are arranged in the solvent 106 and are hence in contact with the solvent 106. The reservoir 105 comprises a first redox mediator 107 for enabling a redox reaction at the photo electrode 103 and a second redox mediator 108 for enabling a redox reaction at the counter electrode 104.

Each of the first and second redox mediators may potentially have a reduced state or an oxidized state, as known per se. Each of the first and second redox mediators may form different entities (e.g., complexes, compounds, etc.), which are soluble or not, depending on the state of the redox mediator.

In the embodiment as illustrated with reference to FIG. 1, the first redox mediator 107 comprises a couple Y/Y−, wherein Y−, also referenced as 110a, is an entity that is soluble in the solvent 106 when the first redox mediator 107 is in its reduced state and Y, also referenced as 110b is an entity that is insoluble in the solvent when the first redox mediator 107 is in its oxidized state. In the following the first redox mediator 107 is interchangeably denoted as first redox mediator 107 or first redox mediator Y/Y−. The second redox mediator 108 comprises a couple X/X+, wherein X+, also referenced as 111a, is an entity that is soluble in the solvent 106 when the second redox mediator 108 is in its oxidized state and X, also referenced as 111b, is an entity that is insoluble in the solvent when the second redox mediator 108 is in its reduced state. In the following the second redox mediator 108 is interchangeably denoted as second redox mediator 108 or second redox mediator X/X+. For illustration purposes, the insoluble entity Y is illustrated with a triangle and the insoluble entity X is illustrated with a square.

The device 100 may be operated in a charging cycle to charge electrical energy in the device 100. In a discharging cycle the device 100 may provide electrical energy.

FIG. 1 illustrates an embodiment of the charging cycle. In the charging cycle solar light shines on the photo electrode 103. Due to the corresponding solar spectrum excitation electrons are injected by the photo dye 101 into the semiconductor layer 102. In other words, during the charging cycle the sunlight shining on the photo electrode 103 initiates charge transfer into the conduction band of the semiconductor layer 102 through the photo-excited photo-dye 103. The solar spectrum excitation may be embodied as in a conventional DSSC cell and photo dyes known from DSSC cells may be used and chosen such that its lowest unoccupied molecular orbital (LUMO) is slightly higher in energy than the conduction band of the semiconductor layer 102. The semiconductor layer 102 comprises according to this embodiment TiO2 particles/grains 102a.

The electrons injected into the conduction band of the semiconductor layer 102 flow or travel through the photo electrode 103 including the semiconductor layer 102 via an external charging circuit 121 to the counter electrode 104.

The oxidized photo dye 101 is subsequently reduced by the first redox mediator 107 dissolved in its reduced state in the solvent 106. In doing so, the first redox mediator 107 is oxidized at the photo electrode 103. Accordingly, the first redox mediator changes from an entity Y− in its reduced state to an entity Y in its oxidized state. In this example the entity Y− is an anion that decreases or eliminates its charge which renders it insoluble in the solvent 106. This, in effect, leads to a deposition of the entity Y of the first redox mediator at the photo electrode 103. The latter may be described as photo-deposition/photo-plating rather than electroplating of the neutral form Y of the first redox mediator onto the photo electrode 103. The electrons released by the first redox mediator upon oxidation to the photo electrode reduce the oxidized photo dye 101, thereby bringing it back to a reduced state or ground state that subsequently facilitates again a photo-excitation of the photo dye 101.

The electrons generated as described above at the photo electrode 103 flow or travel via the external charging circuit 121 to the counter electrode 104. With these electrons the second redox mediator 108 is reduced at the counter electrode 104. According to the embodiment as described with reference to FIG. 1, the second redox mediator X/X+ is chosen to be insoluble in the solvent 106 in its reduced state. Hence the second redox mediator gets deposited, in particular electro-deposited, as a reduced entity X at the counter electrode 104.

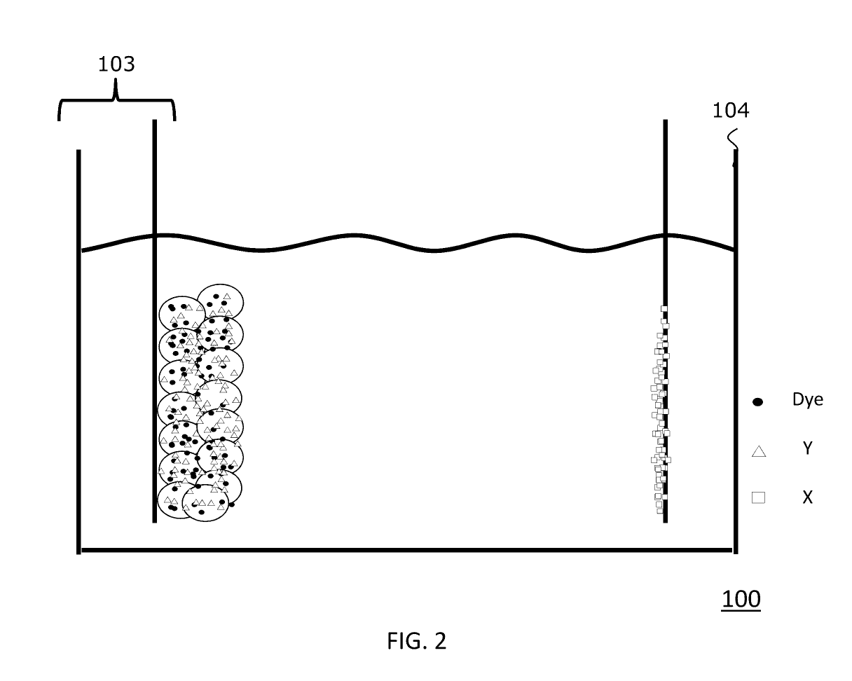

FIG. 2 illustrates the charged state of the device 100 after the charging cycle as described with reference to FIG. 1. As can be seen, the first redox mediator Y/Y− is deposited in its oxidized state as an entity Y at the photo electrode 103. Furthermore, the second redox mediator X/X+ is deposited in its reduced state as an entity X at the counter electrode 104.

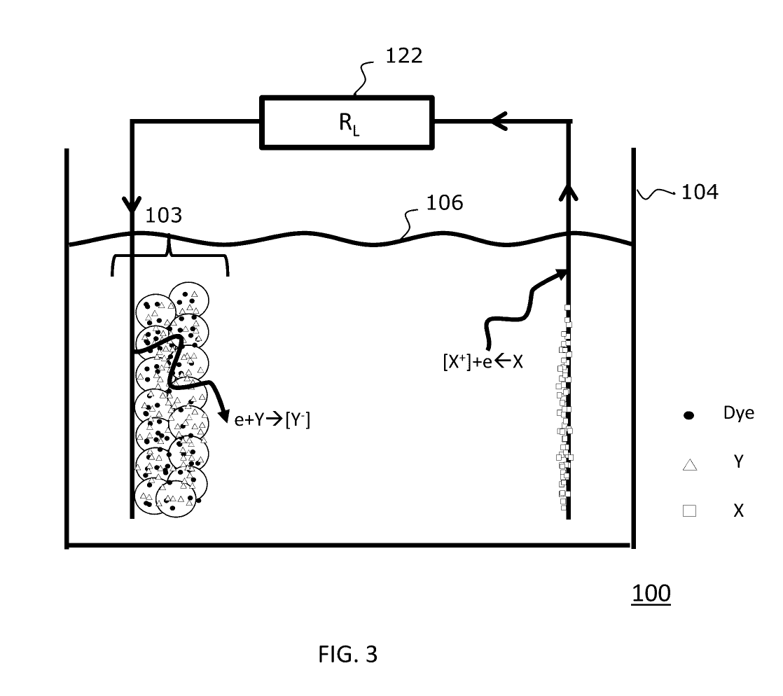

FIG. 3 illustrates an embodiment of a discharging cycle starting from the charged state of FIG. 2. Generally, the discharge potential depends on the redox potentials of the first and the second redox mediators deposited on the photo electrode 103 and the counter electrode 104 during the charging process.

In the discharging cycle the entity X of the second redox mediator is oxidized at the counter electrode 104 and the second redox mediator goes in its oxidized state as entity X+ into the solvent. Concurrently, electrons are released at the counter electrode 104 and the released electrons travel through a discharging circuit 122, which may comprise a load resistance RL, from the counter electrode 104 to the photo electrode 103.

Then, at the photo electrode 103, the first redox mediator is reduced by means of the electrons that travelled/flowed from the counter electrode 104 to the photo electrode 103. Accordingly, the first redox mediator changes from its entity Y in its oxidized state to the entity Y− in its reduced state. As a result, the first redox mediator is dissolved as entity Y− into the solvent 106.

In summary, during the discharging cycle the electrons flow from the counter electrode 104 to the photo electrode 103 and the entities Y and X of the first and the second redox mediators that were deposited during the charging cycle on the photo electrode 103 and the counter electrode 104 respectively go back into the solution comprising the solvent 106 and the entities Y− and X+. Accordingly exemplary embodiments provide a rechargeable and reversible process.

The energetics of the device 100 should preferably be chosen such that the process of dissolving into the solution is spontaneous, i.e., the reduction of the first redox mediator at the photo electrode 103 and the oxidation of the second redox mediator at the counter electrode 104 should be spontaneous once the device 100 is connected to the discharging circuit 122.

The embodiments as described with reference to FIGS. 1-3 allow the direct storage of electrical energy generated from solar energy by a photo dye in a simple and elegant way. While a conventional DSSC cell can only generate electrical energy, but not store energy, embodiments enable to concurrently generate and store electrical energy as described above. In a conventional DSSC cell there is only one redox mediator that is soluble in the solvent during the entire process of charge transfer between the photo electrode and the counter electrode. The most predominant example of redox mediators used for conventional DSSC cells are iodine ions with a reaction as follows:

3I− [symbol] I3−+2e -.

Both I− and I3− are soluble in the solvent to mediate the charge transfer.

According to the embodiment as described with reference to FIGS. 1-3, the first redox mediator may be a hydroquinone/benzoquinone couple or a derivative thereof. Ionized hydroquinone corresponds to the entity Y− of the first redox mediator in its reduced state and is soluble in water. Benzoquinone corresponds to the entity Y of the first redox mediator in its oxidized state and is not soluble in water.

According to embodiments, the oxidation potential of substituted hydroquinone derivatives can be tailored by the media and by the substituents. According to embodiments they may be either charged or uncharged while having appropriate energy and solubility properties.

According to another embodiment, the first redox mediator comprises an iodine/iodide couple.

At the beginning of a charging cycle, the reservoir 105 comprises a solution with iodide and polyvinylpyrrodinone dissolved in the solvent 106. The solvent 106 according to this embodiment is water. During the charging cycle the iodide gets oxidized to iodine and forms in its oxidized state a non-soluble complex polyvinylpyrrodinone-iodine in water at the photo electrode 103. Hence the first redox mediator iodine/iodide forms in its reduced state a first entity iodide that is soluble in the solvent 106 and in its oxidized state as second entity a polyvinylpyrrodinone-iodine complex that is insoluble in the solvent 106.

The above described embodiments for the first redox mediator are two preferred examples, but generally any organic or inorganic compound that is soluble in its reduced state and insoluble in its oxidized state in the respective solvent may be suitable. The energy needed for the charging cycle can be derived from the solar spectrum and should be sufficient to enable the deposition of the first redox mediator on the photo electrode.

According to embodiments, the second redox mediator may be a metal. More particularly, a variety of metal ions. As an example, Cu+, Cu++, Ag+ or Fe++ ions may be used as entity X+ of the second redox mediator in its oxidized state. The metal ions are soluble in the solvent water. The neutral form of the metal ions, e.g. Cu, Ag or Fe, may then form the entities X of the second redox mediator in its reduced state which are insoluble in water. Accordingly, preferred redox couples are e.g. Cu(I)/Cu(0); Cu(II)/Cu(0); Ag(I)/Ag(0) or Fe(II)/Fe(0).

According to another embodiment the second redox mediators may be organic materials, for example Tetra-Thia-Fulvalene (TTF) couples and derivatives thereof or viologen couples and derivatives thereof, the latter being often used for electrochromic displays. These can be reduced during the charging cycle to a lower charged or neutral state, which makes them less soluble/insoluble in the solvent water.

The entity in the reduced state of TTF or the viologens may correspond to ionic forms of these species. As an example, the ionic form TTF++ would form a soluble entity in its oxidized state in the solvent water while the neutral form TTF would form an insoluble entity in its reduced state in the solvent water.

As another example, the ionic form viologen++ may form a soluble entity in its oxidized state in the solvent water while the neutral form of the viologen may form an entity that is insoluble in the solvent water in the reduced state of the second redox mediator.

According to yet another embodiment metalloporphryin couples and derivatives thereof or metallophthalocyanine couples and derivatives thereof may be used as second redox mediator.

According to embodiments, the metalloporphryins and the metallophthalocyanines contain charged metal ions, e.g. Fe, Co and/or Cu ions. These metal ions may enable redox reactions of the metalloporphryins and the metallophthalocyanines, while the porphyrins and phthalocyanines are the ligands that surround the metal ions. As an example, the metalloporphryins and the metallophthalocyanines may comprise Fe+++ ions in their oxidized state which may form an entity that is soluble in the solvent water. Furthermore, the metalloporphryins and the metallophthalocyanines may comprise Fe++ ions in their reduced state which may form an entity that is insoluble in the solvent water.

The above described embodiments for the second redox mediator are preferred examples, but generally any organic/inorganic compound that is soluble in its oxidized state and which is insoluble in its reduced state in the respective solvent may be a candidate.

The energy needed for the charging cycle may be derived from the solar spectrum and should be sufficient to enable the deposition of the second redox mediator on the counter electrode.

For the embodiments discussed above the solvent was preferably water and the solutions aqueous solutions. In embodiments with such aqueous solutions, charged entities/species are dissolved during the discharging cycle and less charged or neutral entities/species are deposited on the electrodes during the charging cycle.

According to further embodiments the solvent may be an organic solvent. In embodiments with organic solutions opposite solubility sequences may be provided such that the first redox mediator is soluble in its less charged or neutral state and insoluble in its higher charged state for deposition on the photo electrode during the charging cycle.

In the embodiments as described with reference to FIGS. 1-3 it is assumed that the entities Y− and X+ of the first and the second redox mediator will not form a salt XY that may precipitate out of the solution or participate in a solution redox reaction.

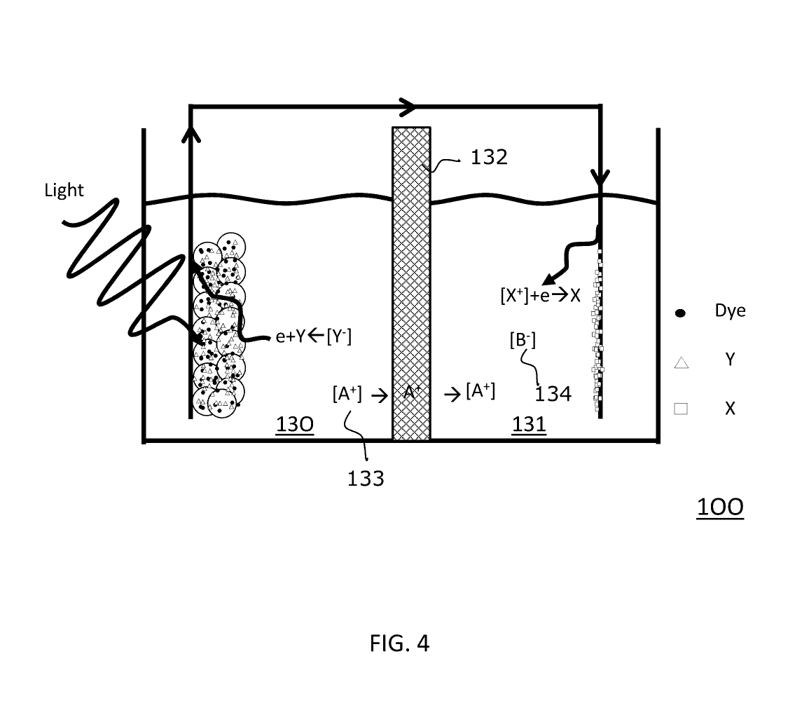

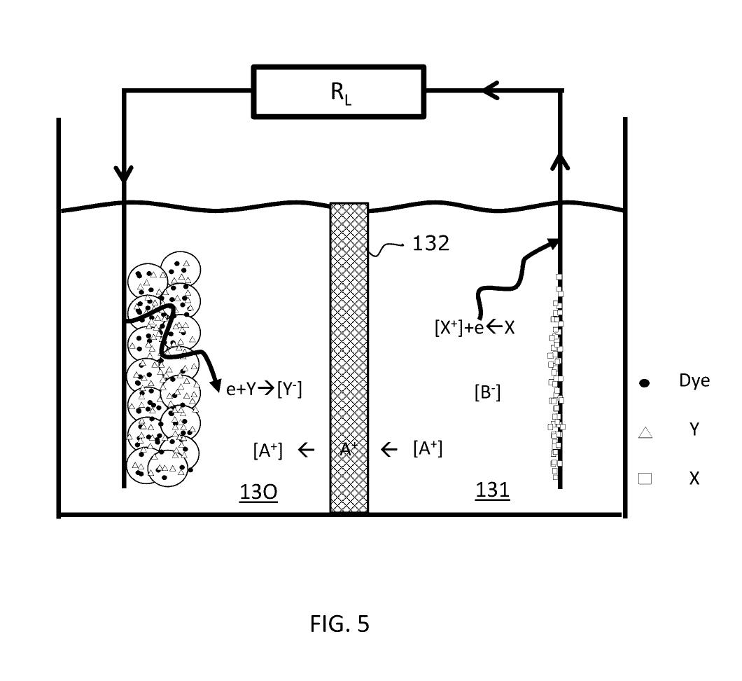

According to another embodiment as illustrated in FIGS. 4 and 5, the reservoir comprises a first half cell 130 and a second half cell 131. The first half cell 130 and the second half cell 131 are separated by a membrane 132.

The first half cell 130 comprises the first redox mediator Y/Y− and the second half cell 131 comprises the second redox mediator X/X+. The membrane 132 is designed to prevent transport of the first redox mediator Y/Y− and the second redox mediator X/X+, more particularly to prevent transport of the soluble entities Y− and X+ of the first and the second redox mediator respectively. According to this embodiment it can be prevented that the entities X+ and Y− react to form a salt XY or participate in a solution redox reaction. The entities X+ and Y− are kept apart by the membrane 132 so that they cannot combine or initiate an electron transfer in the solution itself and cannot precipitate out.

According to this embodiment the solvent 106 comprises cations A+ that remain readily soluble in the aqueous solution. The cations A+ are also referenced with reference numeral 133 and may be e.g. embodied as Li+, Na+ or Mg2+ ions. Furthermore, the solvent 106 comprises anions B− that remain also readily soluble in the aqueous solution. The anions B− are referenced with reference numeral 134. The anions B− may be e.g. SO42−, Cl− or NO3− anions. The membrane 132 is designed to allow transport of the cations A+ to enable charge neutrality in the two half-cells 130 and 131. In other words, the membrane 132 is permeable for the cations A+.

The membrane 132 may be e.g. embodied as organic fuel cell membrane comprising e.g. nafion—sulphonic acid based polymers.

FIG. 4 shows the charging cycle of the device 100 comprising the membrane 132 and FIG.

5 the discharging cycle. With respect to the redox reactions of the first and the second redox mediators, the charging cycle and the discharging cycle correspond to the reactions as described with reference to FIGS. 1-3.

In addition, during the charging cycle shown in FIG. 4 the small cations A+ transfer from the left first half cell 130 through the membrane 132 to the right second half cell 131 and thereby maintain the charge neutrality in the two half cells 130 and 131.

During the discharging cycle shown in FIG. 5 the small cations A+ transfer through the membrane 132 from the right second half cell 131 to the left first half cell 130 and thereby maintain the charge neutrality in the two half cells 130 and 131.

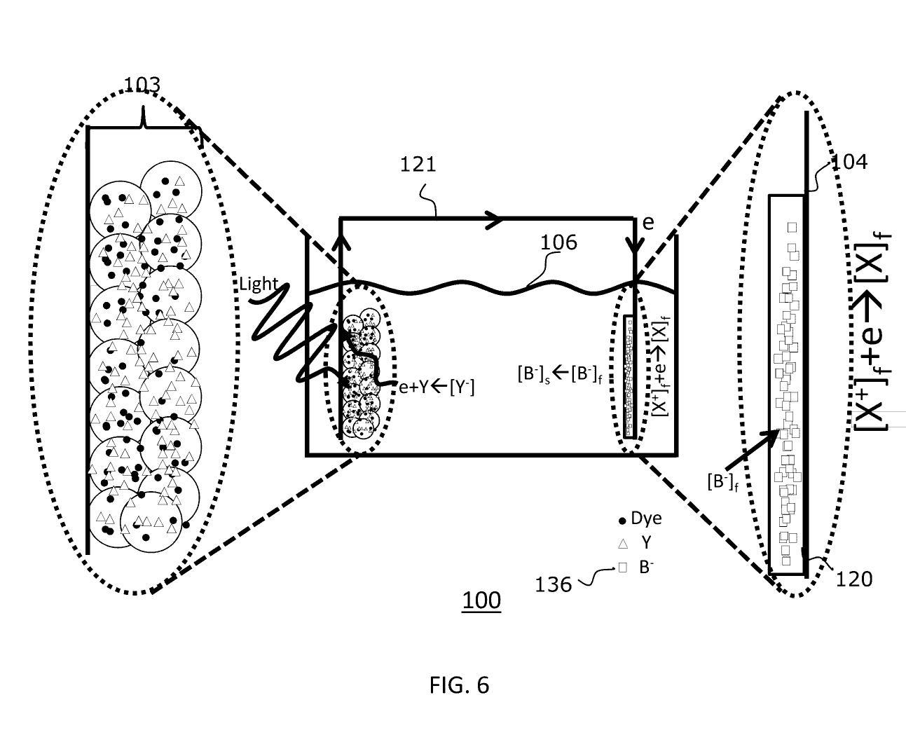

FIG. 6 shows a device 100 according to another embodiment. The counter electrode 104 comprises a layer of an insoluble coating 120. The coating 120 comprises the second redox mediator X/X+. The second redox mediator X/X+ may be e.g. embedded in various forms in the coating 120, in particular in a monomeric or polymeric form. The coating 120 provided on the counter electrode 104 is redox active, thereby enabling a redox reaction at the counter electrode 104. FIG. 6 illustrates the charging cycle of the device 100. On the side of the photo electrode 103 the charging cycle corresponds to the charging cycle as described with reference to FIGS. 1-3. Accordingly upon solar spectrum excitation on the photo electrode 103, electrons are injected by the photo dye 101 into the semiconductor layer 102. The electrons travel via the charging circuit 121 from the photo electrode 103 to the counter electrode 104. The first redox mediator Y/Y− is oxidized and deposited at the photo electrode 103. The oxidization reaction releases electrons to the photo electrode 103 and reduces the oxidized photo dye 101.

According to this embodiment, the entity X+ of the second redox mediator on the side of the counter electrode 104 is not in the solution at the beginning of the charging cycle, but embedded in the non-soluble coating 120. The electrons that travel during the charging cycle from the photo electrode 103 to the counter electrode 104 reduce the second redox mediator X/X+, thereby forming an entity X in the reduced state of the second redox mediator. In the oxidized state of the second redox mediator X/X+ represented by the entity X+ the coating 120 comprises a counter anion B− to maintain charge neutrality. Upon reduction of the second redox mediator X/X+ into the entity X of its reduced state, the counter anion B− is released into the solution to maintain charge neutrality. So the reactions at the counter electrode 120 during charging may be described as follows:

[X+]f+e→[X]f, wherein [X+]f and [X]f represent the entities of the second redox mediator in the redox active coating 120, here denoted as redox active film f;

[B−]s ←[B−]f, wherein [B−]f represents anions in the redox active coating/film 120 and [B−]s represents anions in the solution/dissolved in the solvent 106.

During the discharge process in the absence of light, the reverse occurs. The second redox mediator is oxidized at the counter electrode 104 to its oxidized entity X+, thereby releasing electrons that travel through the discharging circuit 122 to the photo electrode 103. Concurrently the counter anions B− are deposited at/into the coating 120. Then at the photo electrode 103 the first redox mediator is reduced by means of the electrons received from the counter electrode 104 and the first redox mediator is dissolved into the solvent 106.

The coating 120 may be embodied as a redox active polymer comprising the second redox mediator. In such embodiments the second redox mediator may be embodied as a polypyrrole couple or derivatives thereof or as a polyaniline couple or derivatives thereof or as a polythiophene couple or derivatives thereof. Furthermore, the second redox mediator of the redox active polymers may be embodied as a Tetra-Thia-Fulvalene couple or derivatives thereof or as a viologen couple or derivatives thereof or as a metallo-porphyrin couple or derivatives thereof or as a metallophthalocyanine couple or derivatives thereof.

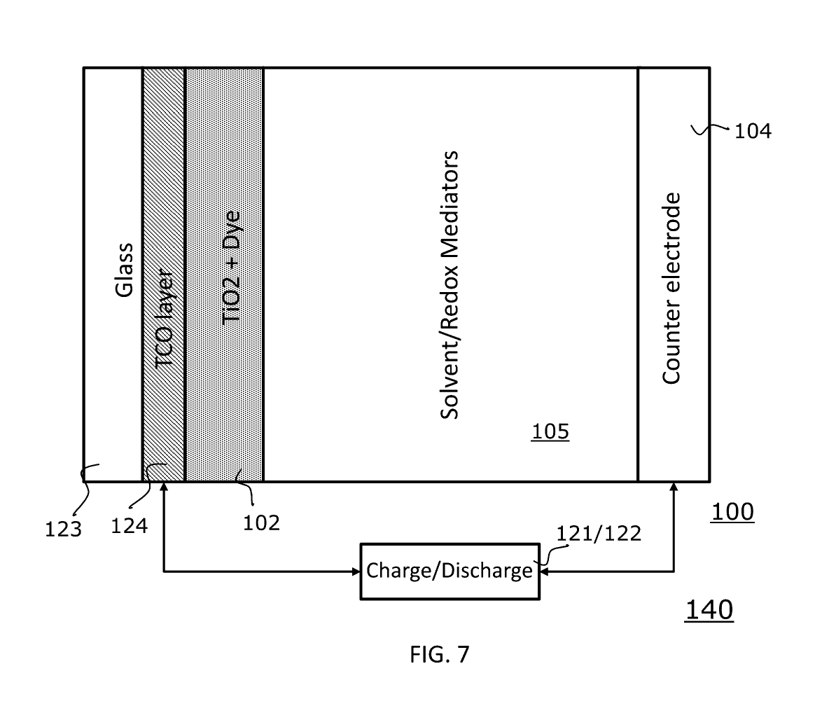

FIG. 7 shows a cross section of an embodiment of the device 100 in more detail, in particular a more detailed embodiment of the photo electrode 103. The photo electrode 103 comprises a transparent glass layer 123 implemented e. g. as glass substrate. Then a TCO layer 124 of a transparent conducting oxide (TCO) is arranged next to the glass layer 123.

Adjacent to the TCO layer 124 the semiconductor layer 102 as described already with reference to FIG. 1 is arranged. The semiconductor layer 102 is in particular embodied as n-type semiconductor comprising TiO2 nanoparticles/grains with a photo dye thereon. In addition, a counter electrode 104 is provided. Between the counter electrode 104 and the semiconductor layer 102 there is reservoir 105 with the solvent 106 and the first and the second redox mediators. According to embodiments the counter electrode 104 may be e.g. a metal electrode comprising e.g. Cu or Ag. If such a metal electrode is arranged in a reservoir 105 comprising water as solvent, the metal electrode may release metal ions into the aqueous solutions. The TCO layer 124 and the counter electrode 104 can be coupled to a charging circuit 121 and a discharging circuit 122. The device 100, the charging circuit 121 and the discharging circuit 122 provide a system 140 for charging and discharging of the device 100.

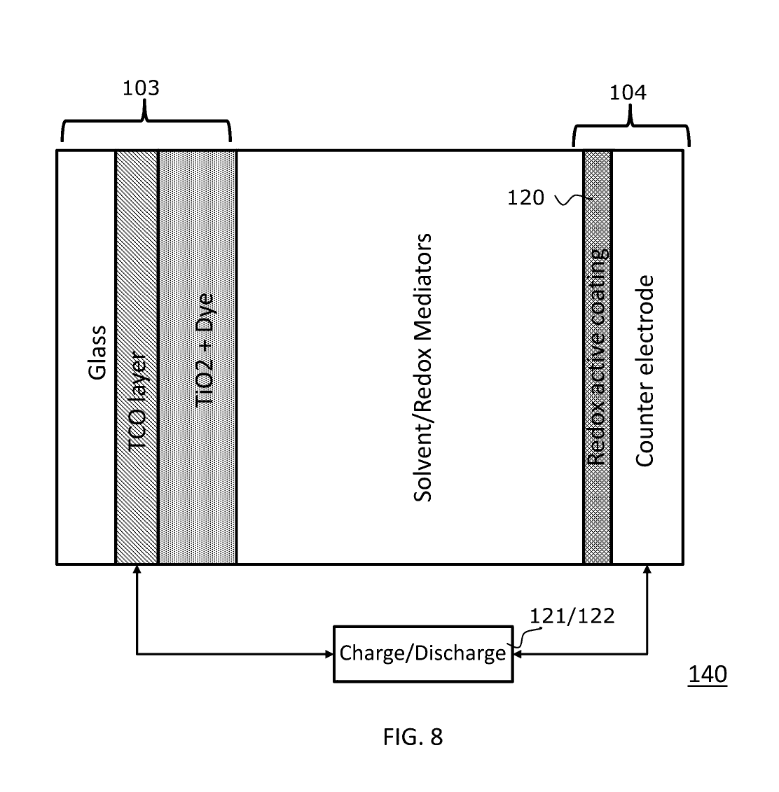

FIG. 8 shows a cross section of another embodiment of the device 100 in more detail. The photo electrode 103 may be embodied in the same way as described with reference to FIG. 7. The counter electrode 104 is embodied as a counter electrode comprising a redox active coating 120 corresponding to the redox active coating 120 as described with reference to FIG. 6.

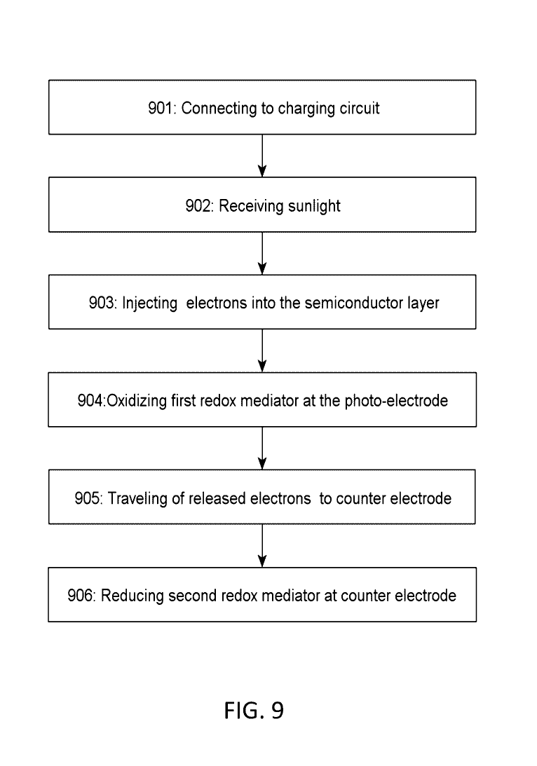

FIG. 9 shows a flowchart of method steps of a charging cycle;

At a step 901, the device 100 for storing electrical energy is connected to the charging circuit 121.

At a step 902, the device 100 receives sunlight that shines on the photo electrode 103.

At a step 903, due to the solar spectrum excitation, electrons are injected by the photo dye 101 into the semiconductor layer 102. The photo dye 101 is thereby oxidized.

At a step 904, the first redox mediator is oxidized at the photo electrode 103, or more particularly at the photo dye 101 of the photo electrode 103. Due to the oxidization, the first redox mediator forms an entity that is insoluble in the solvent 106 and that is hence deposited at the photo electrode 103. As a result, the oxidized photo dye 101 is neutralized back to its ground state.

At a step 905, the injected electrons travel through the photo electrode 103 and the charging circuit 121 to the counter electrode 104.

At a step 906, the second redox mediator is reduced at the counter electrode 104 by means of the electrons that travelled from the photo electrode 103 to the counter electrode 104. According to some embodiments, as described e.g. with reference to FIG. 1, the second redox mediator is thereby deposited at the counter electrode. According to other embodiments having a non-soluble coating on the counter electrode as described e.g. with reference to FIG. 6, a counter anion is released into the solvent to maintain charge neutrality

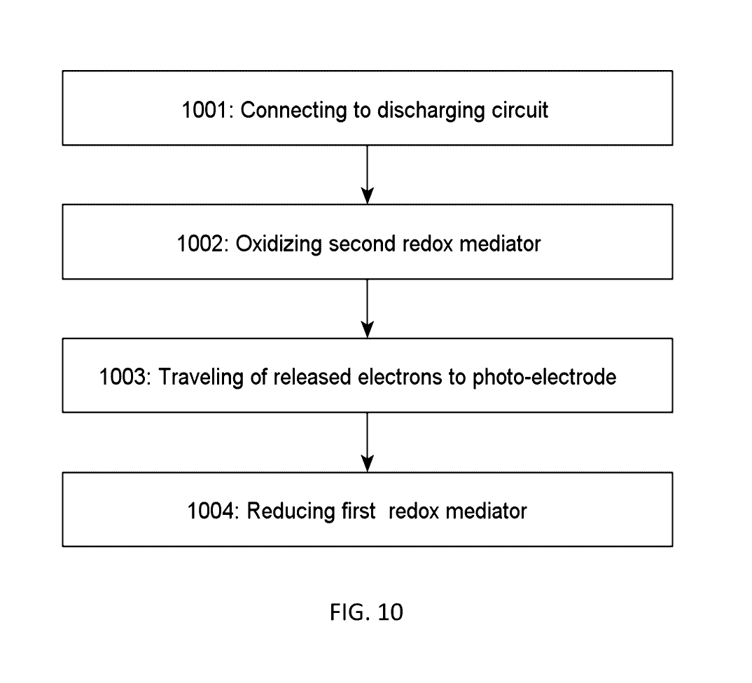

FIG. 10 shows a flowchart of method steps of a discharging cycle according to an embodiment.

At a step 1001, the device 100 is connected to the discharging circuit 122.

At a step 1002, the second redox mediator is oxidized at the counter electrode 104 and as a result electrons are released at the counter electrode 104. According to some embodiments, as described e.g. with reference to FIG. 3, the second redox mediator is thereby dissolved into the solvent. According to other embodiments having a non-soluble coating on the counter electrode as described e.g. with reference to FIG. 6, the counter anion is deposited at the counter electrode or in other words re-embedded into the non-soluble coating to maintain charge neutrality

At a step 1003, the electrons released at the counter electrode 104 travel through the discharging circuit 122 to the photo electrode 103.

At a step 1004 the first redox mediator is reduced at the photo electrode 103 by means of the electrons received from the counter electrode 104. As a result, the first redox mediator is dissolved into the solvent 106.

Embodiments provide that the first redox mediator is kept out of the solvent/solution in its oxidized state and the second redox mediators is kept out of the solution in its reduced state. This allows energy storage during the charging cycle.

Embodiments as described above may provide a device for storing energy which implements a photo battery that uses only sunlight/solar spectrum excitation without a need for an external current source for recharging. This makes the device according to embodiments independent from any electrical grid infrastructure. Embodiments enable the direct storage of electrical energy generated from solar energy by a photo dye in a simple and elegant way.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device for storing electrical energy, comprising:
a photo electrode, having a semiconductor layer with a photo dye thereon;
a counter electrode;
a reservoir comprising a solvent;
a first redox mediator for enabling a redox reaction at the photo electrode;
a second redox mediator for enabling a redox reaction at the counter electrode;
wherein:
the photo electrode and the counter electrode are at least partly in the solvent;
the first redox mediator is adapted to form:
an entity that is soluble in the solvent when the first redox mediator is in its reduced state; and
an entity that is insoluble in the solvent when the first redox mediator is in its oxidized state.

2. A device according to claim 1, wherein the second redox mediator is adapted to form:
an entity that is soluble in the solvent when the second redox mediator is in its oxidized state; and
an entity that is insoluble in the solvent when the first redox mediator is in its reduced state.

3. A device according to claim 1, wherein the working electrode comprises a non-soluble coating, the coating comprising the second redox mediator.

4. A device according to claim 2, the device being operable to perform in a charging cycle the steps of:
injecting, upon solar spectrum excitation, electrons by the photo dye into the semiconductor layer that travel via a charging circuit from the photo electrode to the counter electrode;
oxidizing the first redox mediator at the photo electrode, thereby depositing the first redox mediator at the photo electrode and releasing electrons to the photo electrode in order to reduce the photo dye;
reducing the second redox mediator at the counter electrode by means of the electrons that travelled from the photo electrode to the counter electrode, thereby depositing the second redox mediator at the counter electrode.

5. A device according to claim 2, the device being operable to perform in a discharging cycle the steps of:
oxidizing, at the counter electrode, the second redox mediator, thereby dissolving the second redox mediator into the solvent and releasing electrons at the counter electrode;
travelling of the electrons through a discharging circuit from the counter electrode to the photo electrode;
reducing, at the photo electrode, the first redox mediator by means of the electrons received from the counter electrode, thereby dissolving the first redox mediator into the solvent.

6. A device according to claim 3, the device being operable to perform in a charging cycle the steps of:
injecting, upon solar spectrum excitation, electrons by the photo dye into the semiconductor layer that travel via a charging circuit from the photo electrode to the counter electrode;
oxidizing the first redox mediator at the photo electrode, thereby depositing the first redox mediator at the photo electrode and releasing electrons to the photo electrode in order to reduce the oxidized photo dye;
reducing the second redox mediator at the counter electrode by means of the electrons that travelled from the photo electrode to the counter electrode; and
releasing a counter anion into the solvent to maintain charge neutrality.

7. A device according to claim 3, the device being operable to perform in a discharging cycle the steps of:
oxidizing, at the counter electrode, the second redox mediator, thereby releasing electrons at the counter electrode;
travelling of the electrons through a discharging circuit from the counter electrode to the photo electrode;
depositing a counter anion at the coating;
reducing, at the photo electrode, the first redox mediator by means of the electrons received from the counter electrode, thereby dissolving the first redox mediator into the solvent.

8. A device according to claim 1, wherein the solvent is water.

9. A device according to claim 2, wherein the first redox mediator comprises a hydroquinone/benzoquinone couple and derivatives thereof.

10. A device according to claim 2, wherein the first redox mediator comprises a iodine/iodide couple, wherein the reservoir comprises the solvent, polyvinylpyrrodinone and the iodine/iodide couple and wherein the iodine/iodide couple is adapted to form in its oxidized state a non-soluble entity polyvinylpyrrodinone-iodine at the photo electrode.

11. A device according to claim 2, wherein the second redox mediator comprises a metal.

12. A device according to claim 11, wherein the second redox mediator is selected from the group consisting of: Cu(I)/Cu(0); Cu(II)/Cu(0); Ag(I)/Ag(0) and Fe(II)/Fe(0).

13. A device according to claim 2, wherein the second redox mediator is one of:
Tetra-Thia-Fulvalene couples and derivatives thereof; viologen couples and derivatives thereof; metalloporphryin couples and derivates thereof; and
metallophthalocyanine couples and derivatives thereof.

14. A device according to claim 3, wherein the coating is a redox active polymer comprising the second redox mediator, wherein the second redox mediator is selected from the group consisting of: polypyrrole couples and derivatives thereof; polyaniline couples and derivatives thereof; and polythiophene couples and derivatives thereof.

15. A device according to claim 3, wherein the coating is a redox active polymer comprising the second redox mediator, wherein the second redox mediator is selected from the group consisting of: Tetra-Thia-Fulvalene couples and derivatives thereof;
viologen couples and derivatives thereof; metalloporphyrin couples and derivatives thereof; and metallophthalocyanine couples and derivatives thereof.

16. A device according to claim 1, wherein the solvent is an organic solvent.

17. A device according to claim 1, wherein the reservoir comprises a first half cell and a second half cell, the first half cell and the second half cell separated by a membrane, wherein the first half cell comprises the first redox mediator and the second half cell comprises the second redox mediator, the membrane designed to prevent transport of the first redox mediator and the second redox mediator and to allow transport of cations to enable charge neutrality in the first half cell and the second half cell.

18. A method for charging a device according to claim 1, the method comprising:
injecting, upon solar spectrum excitation, electrons by the photo dye into the semiconductor layer that travel via a charging circuit from the photo electrode to the counter electrode;
oxidizing the first redox mediator at the photo electrode, thereby depositing the first redox mediator at the photo electrode and releasing electrons to the photo electrode in order to neutralize the oxidized photo dye;
reducing the second redox mediator at the counter electrode by means of the electrons that travelled from the photo electrode to the counter electrode.

19. A method for discharging a device according to claim 1, the method comprising:
oxidizing, at the counter electrode, the second redox mediator, thereby releasing electrons at the counter electrode;
travelling of the electrons through a discharging circuit from the counter electrode to the photo electrode;
reducing, at the photo electrode, the first redox mediator by means of the electrons received from the counter electrode, thereby dissolving the first redox mediator into the solvent.

20. A system comprising a device according to claim 1, a charging circuit for charging the device and a discharging circuit for discharging the device.
